(19) United States
(12) Patent Application Publication
(10) Pub. No.: US 2026/0183953 A1
(43) Pub. Date: Jul. 2, 2026

(54) METHOD FOR CONTROLLING ROBOT, ROBOT, AND STORAGE MEDIUM

(71) Applicant: HON HAI PRECISION INDUSTRY CO., LTD., New Taipei (TW)

(72) Inventors: YOUNG-WAY LIU, New Taipei (TW); CHIN-PIN KUO, New Taipei (TW); CHIH-TE LU, New Taipei (TW); JUNG-HAO YANG, New Taipei (TW); TSUNG-WEI LIU, New Taipei (TW); CHIEH LEE, New Taipei (TW); YU-HSUAN CHIEN, New Taipei (TW); YU-KAI ZHOU, New Taipei (TW)

(21) Appl. No.: 19/172,910

(22) Filed: Apr. 8, 2025

(30) Foreign Application Priority Data
Dec. 28, 2024 (CN) 202411955545.8

(51) Int. Cl. B25J 9/16; B25J 13/08

(52) U.S. Cl. CPC B25J 9/1666; B25J 9/1697; B25J 13/085; B25J 13/089

(57) ABSTRACT

A method for controlling a robot, a robot and a storage medium are provided by present application. The method includes determining a motion state of the robot based on preset information corresponding to the robot; in response that the motion state is in a non-balanced state, obtaining a motion plan corresponding to the balance-assistance assembly; controlling the motion state of the robot to change to the balanced state by controlling the balance-assistance assembly to move based on the motion plan. The method may improve balance performance of the robot.

### FIELD

The object to be tested matter herein generally relates to a field of intelligent control technology, and in particular to a method for controlling a robot, a robot and a storage medium.

### BACKGROUND

A robot that can move autonomously may be utilized in various fields to assist in improving efficiency and accuracy of work.

In related technologies, research on the robot has mostly focused on design of a body structure of the robot, relying on movement of the robot's mechanical legs to adjust its motion and balance. However, in a more complex environment, the balance performance of the robot is relatively poor.

### BRIEF DESCRIPTION OF THE DRAWINGS

FIG. 1 is a structural diagram of a robot provided by an embodiment of the present application.

FIG. 2 is a flowchart of a method for controlling a robot provided by an embodiment of the present application.

FIG. 3 is a schematic flowchart of determining a motion state provided by a first embodiment of the present application.

FIG. 4 is a schematic flowchart of determining a motion state provided by a second embodiment of the present application.

FIG. 5 is a schematic flowchart of determining a motion state provided by a third embodiment of the present application.

FIG. 6 is a schematic flowchart of determining a motion state provided by a fourth embodiment of the present application.

FIG. 7 is a structural diagram of a robot control apparatus provided by an embodiment of the present application.

FIG. 8 is a structural diagram of a robot provided by the second embodiment of the present application.

### DETAILED DESCRIPTION

The embodiments of the present application are described in detail below. Examples of the embodiments are illustrated in the accompanying drawings, where the same or similar reference numerals throughout denote the same or similar elements or elements having the same or similar functions. The embodiments described below with reference to the accompanying drawings are exemplary and are intended to explain the present application but should not be construed as limiting the present application.

In the description of the present application, it should be understood that the terms indicating orientation or positional relationships are based on the orientation or positional relationships shown in the drawings, and are only for the convenience of describing the present application and simplifying the description, rather than indicating or implying that the referred devices or elements must have a specific orientation or be constructed and operated in a specific orientation. Therefore, they should not be construed as limiting the present application. In addition, the terms “first” and “second” are used for descriptive purposes only and should not be construed as indicating or implying relative importance or implicitly specifying the number of the indicated technical features. Thus, features defined by “first” and “second” may explicitly or implicitly include one or more of the features. In the description of the present application, it should be noted that the term “a plurality of” means two or more, unless otherwise explicitly and specifically defined.

In the description of the present application, it should be noted that, unless otherwise explicitly specified and defined, the terms “installed,” “connected,” and “coupled” should be understood broadly. For example, they may refer to fixed connections, detachable connections, or integral connections; they may refer to mechanical connections, electrical connections, or communication connections; they may refer to direct connections or indirect connections through an intermediate medium; they may refer to internal connections between two elements or interaction relationships between two elements. For those skilled in the art, the specific meanings of the above terms in the present application may be understood according to specific circumstances.

A robot that can move autonomously may be utilized in various fields to assist in improving efficiency and accuracy of work. The embodiments of the present application are described by taking a humanoid robot as an example. The humanoid robot includes multiple joints, such as leg joints, arm joints, etc. When the humanoid robot walks through the leg joints, it may generate additional momentum by swinging the arm joints to adjust a center of gravity of the humanoid robot, thereby maintaining a balanced state. However, in more complex scenarios such as when the humanoid robot is carrying objects or when the workspace is too narrow to allow normal swinging of the arm joints, the humanoid robot lacks an additional momentum adjustment mechanism during walking, making it susceptible to external environmental disturbances and resulting in poor balance performance.

In view of the above problems, the embodiments of the present application provide a method for controlling the robot, a robot control apparatus, a robot, and a storage medium, which may improve the balance performance of the robot.

The following will describe some embodiments of the present application in detail with reference to the accompanying drawings.

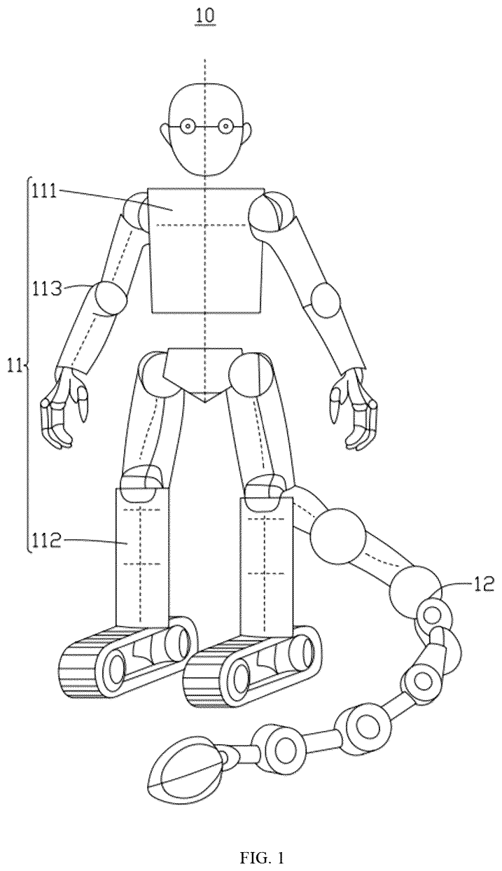

FIG. 1 is a structural diagram of a robot provided by a first embodiment of the present application. As shown in FIG. 1, the robot 10 includes a robot body 11 and a balance-assistance assembly 12. The balance-assistance assembly 12 is connected to the robot body 11 and is used to assist in adjusting balanced state of the robot 10.

In some embodiments, the robot body 11 may include a biped robot. The robot body 11 includes a torso joint 111, a leg joint 112, and an arm joint 113. The leg joint 112 and the arm joint 113 are both connected to the torso joint 111. In some embodiments, each of the torso joint 111, the leg joint 112, and the arm joint 113 includes multiple joint components. By controlling movement of the multiple joint components, the torso joint 111, the leg joint 112, and the arm joint 113 may be controlled to move accordingly.

In some embodiments, the balance-assistance assembly 12 may be a soft tail, which includes multiple motion components arranged axially in parallel. The shape, size, and number of the motion components may be set according to actual needs. For example, the size and shape of each motion component may be the same. Or the size of each motion component may be different while the shape is the same. Or the size and shape of each motion component may be different, which is not limited herein. By controlling the movement of each motion component of the balance-assistance assembly 12, the balanced state of the robot 10 may be adjusted.

In the robot 10 provided by the embodiments of the present application, the robot 10 includes the robot body 11 and the balance-assistance assembly 12. By controlling the balance-assistance assembly 12 to adjust the balanced state of the robot, the balance performance of the robot may be improved.

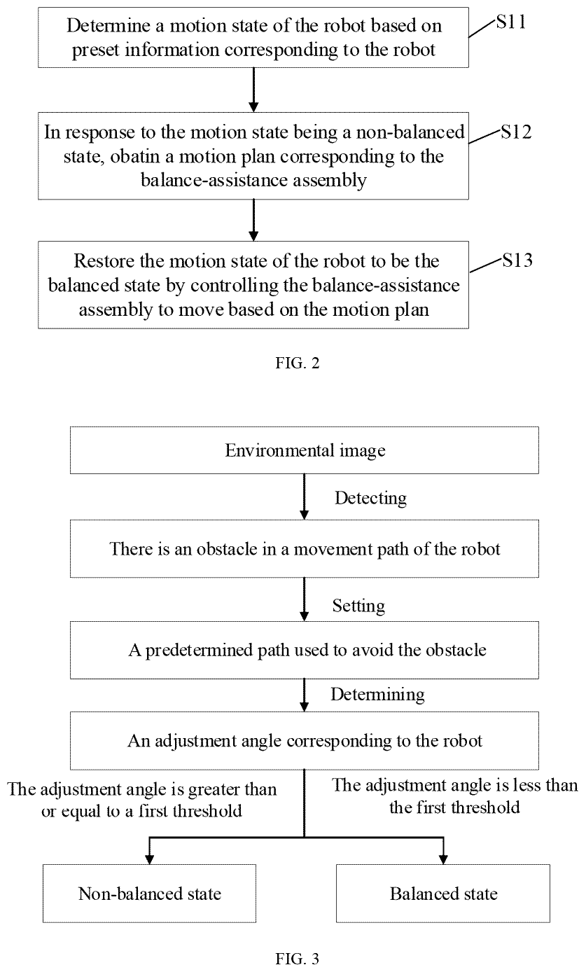

FIG. 2 is a flowchart of a method for controlling a robot provided by an embodiment of the present application. The method for controlling the robot is applied to a robot (e.g., the robot 10 in FIG. 1). As shown in FIG. 2, the method includes the following steps:

S11: A motion state of the robot is determined based on preset information corresponding to the robot.

In at least one embodiment of the present application, the preset information may be used to analyze the motion state of the robot. The method for determining the preset information of the robot may include determining an environmental image, position information, force information, and posture information corresponding to the robot, and determining the preset information based on the environmental image, the position information, the force information, and the posture information. The environmental image may represent an external environmental image within a preset range centered on the robot, and the preset range may be determined based on a focal length of a camera of the robot. The position information may represent a current position of the robot. The robot may obtain the current position in various ways. For example, the robot may use Real-Time Kinematic (RTK) technology to obtain the current position. The force information may represent the pressure distribution between the robot and the external environment. For example, the force information may include a gripping force of the robot's arm joint on an object and a touch force of other objects on the robot. The force information may be measured by a pressure sensor of the robot. The posture information may represent the position and orientation of the robot in space and may be determined by a gyroscope, an accelerometer, and an Inertial Measurement Unit (IMU). In some embodiments, one or more combinations of the environmental images, the position information, the force information, and the posture information may be used as the preset information, which is not limited herein.

In some embodiments, the motion state may include a balanced state and a non-balanced state. Based on the environmental image and the position information corresponding to the robot, it is possible to determine whether there is an obstacle located at the robot's movement path, determine the flatness of an operational area where the robot is located, and determine the narrowness of the operational area where the robot is located. Based on the obstacle information, the motion state of the robot may be determined. Based on one or more of the flatness and narrowness of the operational area, the motion state of the robot may be assisted in determining. Based on the force information and posture information of the robot, a tilt angle of the robot may be checked. Based on the tilt angle, the motion state of the robot may be determined. The embodiments of the present application determine the motion state of the robot through multi-dimensional analysis, which may improve the accuracy of motion state determination.

S12: in response that the motion state is in a non-balanced state, a motion plan corresponding to the balance-assistance assembly is obtained.

In at least one embodiment of the present application, in response to the motion state being a balanced state, the preset information of the robot continues to be determined, and the motion state of the robot is determined based on the preset information. In response to the motion state being a non-balanced state, multiple components of the robot need to be adjusted to control the motion state of the robot to the balanced state.

In some embodiments, when adjusting the components of the robot, it may include adjusting the joint of the robot body and the motion components of the balance-assistance assembly. To precisely control the robot's movement, a robot motion model may be established in advance, which includes modeling geometric relationships, kinematic, and dynamic of each component of the robot. Through the robot motion model, the movement path and state of the robot under given control parameters may be determined. In some embodiments, a balance control algorithm is used to determine control parameters based on the robot motion model and the measured preset information. The robot adjusts the movement path of each component according to the control parameters to ensure balance during movement. The balance control algorithm includes a Proportional-Integral-Derivative (PID) control algorithm, an adaptive control algorithm, a fuzzy control algorithm, etc. The specific control processes of these algorithms may refer to related technologies and will not be elaborated here.

In some embodiments, by controlling the balance-assistance assembly to assist in adjusting the robot's balanced state, the motion plan corresponding to the balance-assistance assembly is determined by: determining a motion component and motion information of the balance-assistance assembly based on the preset robot motion model and the preset information; and obtaining the motion plan based on the motion component and the motion information. The motion information may represent the motion parameters of each motion component, such as motion plan, motion speed, etc. The motion information of multiple motion components in the balance-assistance assembly is used as the motion plan for the balance-assistance assembly. In some embodiments, taking the adaptive control algorithm as an example, the adaptive control algorithm determines the control parameters based on the robot motion model and the measured preset information. For example, at least one of the environmental images, position information, force information, and posture information corresponding to the robot is used as input data, and the robot motion model is also used as input data, which is fed into the model corresponding to the adaptive control algorithm (e.g., an adaptive control model). The output data of the adaptive control model is the control parameters. Subsequently, the robot may determine the motion components of the balance-assistance assembly, and the motion information based on the control parameters.

S13: the motion state of the robot is controlled to change to a balanced state by controlling the balance-assistance assembly to move based on the motion plan.

In at least one embodiment of the present application, based on the motion plan, the motion components of the balance-assistance assembly to be controlled and the motion information may be determined. By controlling the motion components to move according to the motion information through the processor, the motion state of the robot may be restored to be the balanced state.

The method for controlling the robot provided by the embodiments of the present application determines the motion state of the robot based on the preset information corresponding to the robot, in response to the motion state is a non-balanced state, the motion plan corresponding to the balance-assistance assembly is determined; and based on the motion plan, the balance-assistance assembly is controlled to move, bringing the robot into the balanced state. By controlling the balance-assistance assembly to adjust the robot's balanced state, the balance performance of the robot may be improved.

In at least one embodiment of the present application, based on the environmental image and position information corresponding to the robot, it is possible to determine whether there is an obstacle located at robot's movement path. Based on the obstacle information, the motion state of the robot may be determined. Referring to FIG. 3, which illustrates the flowchart for determining the motion state according to the first embodiment of the present application. As shown in FIG. 3, determining the motion state of the robot based on the preset information includes: if there is an obstacle located at robot's movement path that is determined according to the environmental image, a predetermined path to avoid the obstacle for the robot is determined according to the position information, an adjustment angle is determined corresponding to the robot based on the predetermined path. In response that the adjustment angle is greater than or equal to a first threshold, the motion state of the robot is determined to be a non-balanced state; and in response that the adjustment angle is less than the first threshold, the motion state of the robot is determined to be a balanced state.

In some embodiments, the environmental image may represent an external environmental image within a preset range centered on the robot, and the preset range may be determined based on a focal length of a camera of the robot. The movement path may represent a pre-set operational path for the robot. For example, when the robot is used to transport the object, the movement path may be pre-set to allow the robot to transport the object to a designated location.

In some embodiments, the obstacle may refer to an object that hinders or obstructs the robot's movement, including but not limited to a stone, a tree root, a pile of leaves, a toy, a sport equipment, an animal, and a pedestrian. In some embodiments, determining whether there is the obstacle located at robot's movement path based on the environmental image includes: obtaining a preset reference image; calculating a similarity between the environmental image and the preset reference image; in response that the similarity between the environmental image and the reference image is greater than or equal to a preset similarity value, determining that there is no obstacle located at movement path; and in response that the similarity between the environmental image and the reference image is less than the preset similarity value, determining that there is an obstacle located at movement path. The reference image is a pre-set image that does not contain obstacles. The preset similarity value may be set according to actual needs and is not limited herein. In other embodiments, the robot is equipped with preset sensors to detect whether there is an obstacle located at current movement path. The preset sensors may be set according to actual needs, including but not limited to a collision sensor, a depth sensor, an ultrasonic sensor, and an infrared sensor. For example, the preset sensor may collect detection data from the current movement path in real-time or at preset intervals. By parsing the detection data, it is possible to determine whether there is an obstacle located at movement path. A type of the detection data may be determined by the type of the preset sensor. For example, the detection data collected by the collision sensor is impact data, the detection data collected by the depth sensor is depth data, the detection data collected by the ultrasonic sensor is ultrasonic data, and the detection data collected by the infrared sensor is infrared data.

In some embodiments, if it is determined that there is an obstacle located at robot's movement path, a path used to avoid the obstacle for the robot is determined according to the position information includes: characteristic information corresponding to the obstacle is determined; and the predetermined path is generated based on a preset operational map, position information of the robot, and the characteristic information. The operational map may be a Global Positioning System (GPS) map, which may include a two-dimensional or a three-dimensional scene map. In practical applications, the form of the operational map is not limited. In some embodiments, the characteristic information corresponding to the obstacle may include shape, contour, and position of the obstacle. By determining the characteristic information of the obstacle and generating the predetermined path based on the characteristic information, the robot may completely bypass the obstacle, improving the accuracy of determining the predetermined path and ensuring operational safety of the robot. In some embodiments, the predetermined path may be a polyline composed of three segments of lines, allowing the robot to work along the polyline to bypass the obstacle. In other embodiments, the predetermined path may also be an arc, allowing the robot to work along the arc to bypass the obstacle. The shape of path used to avoid the obstacle may be set according to actual needs and is not limited herein.

In some embodiments, the adjustment angle is determined corresponding to the robot based on the predetermined path by determining a first direction corresponding to an initial movement path and a second direction corresponding to the predetermined path; and determining the adjustment angle corresponding to the robot based on the first direction and the second direction. The first direction may represent a direction when the robot is moving on the initial movement path, and the second direction may represent a direction when the robot is at a starting point of the predetermined path. Based on the first direction and the second direction, the adjustment angle that the robot needs to adjust when moving along the predetermined path may be determined. For example, a difference between an angle corresponding to the first direction and an angle corresponding to the second direction is taken as the adjustment angle corresponding to the robot.

In some embodiments, in response that the adjustment angle is greater than or equal to the first threshold, the motion state of the robot is determined to be a non-balanced state; in response that the adjustment angle is less than the first threshold, the motion state of the robot is determined to be the balanced state. The first threshold may be determined based on the relevant attributes of the robot, such as weight, height, width, etc. In response that the adjustment angle is greater than or equal to the first threshold, it indicates that the robot needs to make a significant turn to avoid the obstacle, and the motion state of the robot is determined to be a non-balanced state. In response that the adjustment angle is less than the first threshold, it indicates that the robot only needs to make a slight turn to avoid the obstacle, and the motion state of the robot is determined to be the balanced state.

In the method for controlling the robot provided by the embodiments of the present application, based on the environmental image and the position information corresponding to the robot, it is possible to determine whether there is an obstacle located at robot's movement path. Based on the characteristic information of the obstacles, the motion state of the robot may be determined. The above method determines the motion state of the robot based on obstacle information, improving the accuracy of motion state determination and enabling timely adjustment of the robot to enhance its balance performance.

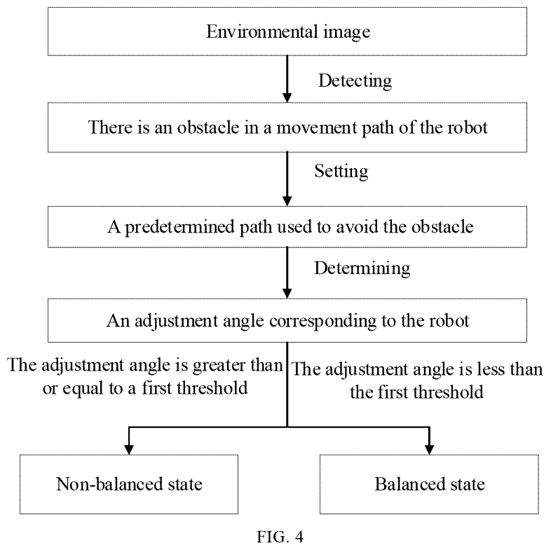

In at least one embodiment of the present application, based on the environmental image corresponding to the robot, a flatness of an operational area where the robot is located may be determined, and the motion state of the robot may be determined based on the flatness. Referring to FIG. 4, which illustrates the flowchart for determining the motion state according to the second embodiment of the present application, as shown in FIG. 4, the motion state of the robot based on the preset information is determined by determining the flatness of the operational area where the robot is located based on the environmental image; in response that the flatness is less than or equal to a second threshold, adjusting a movement speed of the robot and determining the motion state of the robot based on force information and posture information; and in response that the flatness is greater than the second threshold, determining the motion state of the robot based on the force information and the posture information.

In some embodiments, the flatness is used to indicate smoothness of the surface of the operational area. The higher the flatness, the smoother the surface of the operational area; the lower the flatness, the more uneven the surface of the operational area. A flatness recognition model is pre-trained and used to determine the flatness of the operational area. The input data for the flatness recognition model is the environmental image, and the output data is the flatness of the operational area of the environmental image. A method for training for the flatness recognition model includes a supervised training method and an unsupervised training method, which are not limited herein.

In some embodiments, the second threshold may be set according to actual needs. In response that the flatness is less than or equal to the second threshold, it indicates that the surface of the operational area is uneven, and a probability of the robot being in a non-balanced state in the operational area is high. The movement speed of the robot may be adjusted, and the motion state of robot may be determined based on the force information and the posture information. The movement speed of the robot may be adjusted by reducing the movement speed. The movement speed may be determined based on the flatness of the operational area. For example, a correspondence relationship between movement speed and the flatness of the operational area may be pre-set. By querying the correspondence relationship, the movement speed corresponding to the current flatness may be determined, facilitating the adjustment of the robot according to the determined movement speed. In response that the flatness is greater than the second threshold, it indicates that the surface of the operational area is smooth, and the probability of the robot being in a non-balanced state in the operational area is low. The current movement speed may be maintained, and the motion state of the robot may be determined based on the force information and the posture information.

In the method for controlling the robot provided by the embodiments of the present application, based on the environmental image corresponding to the robot, the flatness of the operational area where the robot is located may be determined. The probability of the robot being in a non-balanced state can be assisted in determining based on the flatness. When the flatness is low, the movement speed of the robot may be adjusted in time, and the motion state of the robot may be determined. The above method enables timely adjustment of the robot based on the flatness to improve its balance performance.

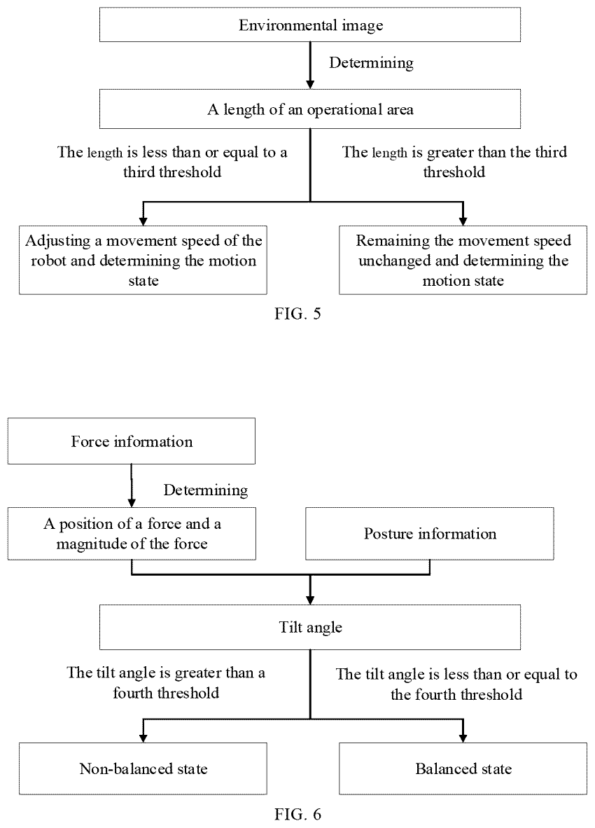

In at least one embodiment of the present application, based on the environmental image corresponding to the robot, a narrowness of the operational area where the robot is located may be determined. The motion state of the robot may be assisted in determining based on narrowness. Referring to FIG. 5, which illustrates the flowchart for determining the motion state according to the third embodiment of the present application, as shown in FIG. 5, determining the motion state of the robot based on the preset information includes: determining a length of the operational area where the robot is located in a preset direction based on the environmental image; in response that the length is less than or equal to a third threshold, adjusting the movement speed of the robot and determining the motion state of the robot based on the force information and the posture information; and in response that the length is greater than the third threshold, determining the motion state of the robot based on the force information and the posture information.

In some embodiments, the preset direction may represent a direction perpendicular to the movement direction. By determining the length of the operational area where the robot is located in the preset direction, it is possible to determine whether the robot's operational area is narrow. In response that the length is less than or equal to the third threshold, it indicates that the robot's operational area is narrow, and it is difficult for the robot to maintain a balanced state in a narrow space. Based on this, the movement speed of the robot needs to be adjusted, and the motion state of the robot may be determined based on the force information and the posture information. Adjusting the movement speed of the robot may include reducing the movement speed. The movement speed of the robot may be determined based on the length of the operational area in the preset direction. For example, a correspondence relationship between the movement speed and the length of the operational area in the preset direction may be pre-set. By querying this correspondence relationship, the movement speed corresponding to the current length may be determined, facilitating the adjustment of the robot according to the determined movement speed. In response that the length is greater than the third threshold, it indicates that the operational area is spacious, and it is easier for the robot to maintain a balanced state in a spacious space. Based on this, the movement speed may be maintained, and the motion state of the robot may be determined based on the force information and the posture information. The third threshold may be determined based on the relevant attributes of the robot (e.g., width) and is not limited herein.

In some embodiments, a region length determination model may be pre-trained. The region length determination model is used to determine the narrowness of the operational area where the robot is located based on the environmental image. The input data for the region length determination model is the environmental image, and the output data is the length of the operational area where the robot is located in the preset direction. A training method for the region length determination model includes a supervised method or an unsupervised method, which is not limited herein.

In the method for controlling the robot provided by the embodiments of the present application, based on the environmental image corresponding to the robot, the narrowness of the operational area where the robot is located may be determined. Based on the narrowness, the probability of the robot being in a non-balanced state may be determined. When the operational area is relatively narrow, the movement speed of the robot may be adjusted in time, and the motion state of the robot may be determined. The above method, based on the narrowness of the operational area of the robot, enables timely adjustment of the robot to improve its balance performance.

In at least one embodiment of the present application, based on the force information and the posture information corresponding to the robot, a tilt angle of the robot may be checked. Based on the tilt angle, the motion state of the robot may be determined. Referring to FIG. 6, which illustrates the flowchart for determining the motion state according to the fourth embodiment of the present application, as shown in FIG. 6, determining the motion state of the robot based on the force information and the posture information includes: determining a position of a force and a magnitude of the force corresponding to the robot based on the force information; determining the motion posture of the robot based on the force position, the magnitude of the force, and the posture information; in response that the robot is tilted according to the motion posture, checking the tilt angle of the robot; in response that the tilt angle is greater than a fourth threshold, determining that the motion state of the robot is in the non-balanced state; and in response that the tilt angle is less than or equal to the fourth threshold, determining that the motion state of the robot is in the balanced state.

In some embodiments, the force information may represent the pressure distribution between the robot and the external environment. For example, the force information may include a gripping force between the arm joint of the robot and an object when the robot is gripping the object and a touch force of other objects on the robot. The force information may include a force position and a magnitude of the force. When the robot is gripping the object, the force position may be the arm position; when other objects are touching the robot, the force position may be the touch position of the other objects on the robot.

In some embodiments, the posture information may represent a position and an orientation of the robot in space and may be determined by a gyroscope, an accelerometer, and an Inertial Measurement Unit (IMU). A robot motion model is pre-established for the robot, which includes a geometric relationship, a kinematic, and a dynamic of each motion component of the robot. The force position, the magnitude of the force, and the posture information corresponding to the robot are input into the robot motion model. Through the robot motion model, it is possible to predict whether the robot is tilted and check the tilt angle of the robot. In response that the tilt angle is greater than the fourth threshold, the motion state of the robot is determined to be a non-balanced state; in response that the tilt angle is less than or equal to the fourth threshold, the motion state of the robot is determined to be the balanced state. The fourth threshold may be set according to actual needs and is not limited herein.

In the method for controlling the robot provided by the embodiments of the present application, based on the force information, the force position and the magnitude of the force corresponding to the robot are determined; based on the force position, the magnitude of the force, and the posture information, the motion posture of the robot is determined, thereby checking the tilt angle of the robot. The above method determines the motion state of the robot based on the tilt angle, improving the accuracy for determining the motion state and enabling timely adjustment of the robot to enhance its balance performance.

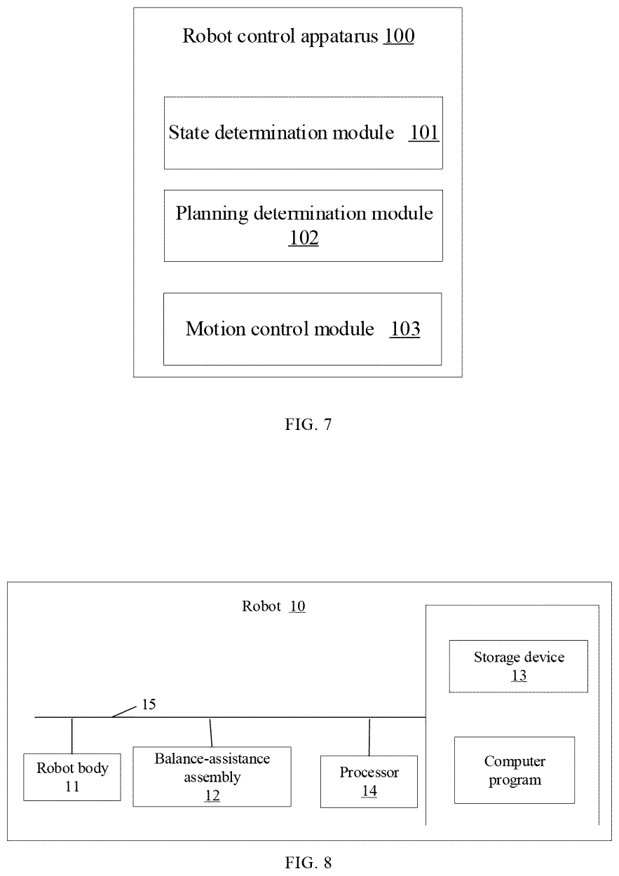

Please refer to FIG. 7, which is a schematic diagram of the structure of the robot control apparatus provided by an embodiment of the present application. In some embodiments, the robot control apparatus 100 may include multiple functional modules composed of computer program segments. The computer programs of each program segment in the robot control apparatus 100 may be stored in the memory of the robot and executed by at least one processor to perform the functions of robot control (as described in detail in FIG. 2).

In some embodiments, the robot control apparatus 100 may be divided into multiple functional modules based on its executed functions. The functional modules may include: a state determination module 101, a planning determination module 102, and a motion control module 103. The term “module” in present application refers to a series of computer program segments executable by at least one processor and capable of performing fixed functions, stored in a memory. In some embodiments, the functions of each module will be elaborated in subsequent embodiments.

The state determination module 101 is used to determine the motion state of the robot based on preset information corresponding to the robot.

The planning determination module 102 is used to obtain the motion plan corresponding to the balance-assistance assembly when the motion state is a non-balanced state.

The motion control module 103 is used to control the motion state of the robot is in the balanced state by controlling the balance-assistance assembly to move based on the motion plan.

It is understood that the robot control apparatus 100 and the method for controlling the robot described in the above embodiments belong to the same inventive concept. The specific implementations of the modules in the robot control apparatus 100 correspond to the steps of the method in the above embodiments, which will not be repeated here.

In some embodiments, the state determination module 101 further includes a visual perception submodule, a position perception submodule, a force perception submodule and posture perception submodule. The visual perception submodule is used to determine an environmental image corresponding to the robot. The position perception submodule is used to determine the position information corresponding to the robot. The force perception submodule is used to determine the force information corresponding to the robot. The posture perception submodule is used to determine the posture information corresponding to the robot.

In some embodiments, the planning determination module 102 further includes a balance control submodule and a navigation control submodule. The balance control submodule is configured to obtain the motion plan corresponding to the robot when the motion state is a non-balanced state, including the motion plan for the robot body and the motion plan for the balance-assistance assembly. The navigation control submodule is configured to determine the movement path of the robot in response to a task instruction, where the task instruction may include information such as a starting position of the task, an ending position of the task, and the number of objects to be transported.

In some embodiments, the motion control module 103 further includes an action generation submodule and an action execution submodule. The action generation submodule is configured to determine the motion plan of each moving component of the balance-assistance assembly based on the motion plan. The action execution submodule is configured to control each moving component in the balance-assistance assembly to move according to the motion plan.

The division of modules described above is based on logical functions, and in practice, they may be divided differently. Additionally, the functional modules in the various embodiments of this application may be integrated into the same processing unit, or each module may exist as a separate physical entity, or two or more modules may be integrated into the same unit. The integrated modules may be implemented in hardware or in the form of hardware combined with software functional modules.

FIG. 8 is a schematic diagram of the structure of a robot provided by the second embodiment of this application. As shown in FIG. 8, the robot 10 includes a storage device 13, at least one processor 14, and at least one communication bus 15. The at least one processor 14 is configured to execute the computer program stored in the storage device 13 to implement the robot control method. The communication bus 15 is configured to enable communication between the robot body 11, the balance-assistance component 12, the storage device 13, and the at least one processor 14.

Those skilled in the art should understand that the structure of the robot shown in FIG. 8 does not constitute a limitation to the embodiments of the present application. The robot 10 may also include more or fewer other hardware or software components than those illustrated, or different component arrangements.

In some embodiments, the robot 10 is a device capable of automatically performing numerical calculations and/or information processing according to pre-set or stored instructions. It's hardware includes but is not limited to microprocessors, application-specific integrated circuits, programmable gate arrays, digital processors, and embedded devices, among others. The robot 10 may also be connected to user devices, which include, but are not limited to, any electronic product that can interact with users through keyboards, mice, remote controls, touchpads, or voice-controlled devices, such as personal computers, tablets, smartphones, digital cameras, etc. The connection methods may include wireless and wired connections. When the robot 10 is wired to a user device, communication can be established through charging cables or data cables. When the robot 10 is wirelessly connected to a user device, it can be connected via wireless communication methods such as Bluetooth, Wi-Fi, ZigBee, or cellular networks.

It should be noted that the robot 10 is merely an example. Other existing or future electronic products that may be adapted to the present application should also be included within the scope of protection of the present application and are incorporated herein by reference.

Although not shown, a power supply connected to the robot 10 may include one or more DC or AC power sources, recharging devices, power failure detection circuits, power converters or inverters, power status indicators, and any other components. The robot 10 may also include various sensors, Bluetooth modules, Wi-Fi modules, etc., which will not be elaborated here.

In some embodiments, the storage device 13 stores a computer program, and when the computer program is executed by the at least one processor 14, it implements all or part of the steps of the method for controlling the robot described in the present application. The storage device 13 includes a read-only memory (ROM), a programmable read-only memory (PROM), an erasable programmable read-only memory (EPROM), a one-time programmable read-only memory (OTPROM), an electrically-erasable programmable read-only memory (EEPROM), a compact disc read-only memory (CD-ROM), other optical disc storage, a magnetic disk storage, a magnetic tape storage, or any other medium capable of carrying or storing computer-readable data.

In some embodiments, the computer-readable storage medium mainly includes a program storage area and a data storage area. The program storage area may store an operating system, applications required for at least one function, etc. The data storage area may store data created based on the use of the robot 10.

In some embodiments, the at least one processor 14 is the control core of the robot 10, connecting various components of the robot 10 through various interfaces and lines. By running or executing programs or modules stored in the storage device 13 and invoking data stored in the storage device 13, it performs various functions and processes data for the robot 10. For example, the at least one processor 14 executes the computer program stored in the storage device to implement all or part of the steps of the method for controlling the robot in the embodiments of the present application, or to implement all or part of the functions of the robot control apparatus. The at least one processor 14 may be composed of integrated circuits, such as a single packaged integrated circuit or multiple integrated circuits with the same or different functions, including one or more central processing units (CPUs), microprocessors, digital processing chips, graphics processors, and various control chips, among others.

The integrated units implemented in the form of software functional modules described above may be stored in a computer-readable storage medium. The software functional modules stored in a storage medium include several instructions to enable a robot (which may be a personal computer, robot, or network device, etc.) or a processor to execute part of the methods described in the embodiments of the present application.

In the several embodiments provided in the present application, it should be understood that the disclosed devices and methods may be implemented in other ways. For example, the device embodiments described above are illustrative. For instance, the division of modules is based on logical functions, and in practice, they may be divided differently.

The modules described as separate components may or may not be physically separated, and the components displayed as modules may or may not be physical units. They may be located in one place or distributed across multiple network units. Some or all of the modules may be selected to achieve the objectives of the embodiments.

In addition, the functional modules in the various embodiments of this application may be integrated into one processing unit or may exist as separate physical units. Two or more units may also be integrated into one unit. The integrated units may be implemented in hardware or in the form of hardware plus software functional modules.

For those skilled in the art, it is clear that this application is not limited to the details of the exemplary embodiments described above. Without departing from the spirit or essential characteristics of this application, the application may be implemented in other specific forms. Therefore, the embodiments should be considered illustrative and not restrictive. The scope of this application is defined by the appended claims rather than the above description. Therefore, all changes that fall within the meaning and range of equivalency of the claims are intended to be included in this application. No reference signs in the claims should be construed as limiting the claims. Furthermore, the term “including” does not exclude other units or components, and the singular does not exclude the plural. Multiple units or devices described in the specification may also be implemented by a single unit or device through software or hardware. Terms such as “first” and “second” are used to denote names and do not imply any specific order.

Finally, it should be noted that the above embodiments are only used to illustrate the technical solutions of this application and are not intended to limit them. Although this application has been described in detail with reference to the preferred embodiments, those skilled in the art should understand that modifications or equivalent replacements may be made to the technical solutions of this application without departing from the spirit and scope of the technical solutions.

What is claimed is:

1. A method of controlling a robot, comprising a robot body and a balance-assistance assembly, the method comprising:
determining a motion state of the robot based on preset information corresponding to the robot;
in response that the motion state is in a non-balanced state, obtaining a motion plan corresponding to the balance-assistance assembly; and
controlling the motion state of the robot to change to a balanced state by controlling the balance-assistance assembly to move based on the motion plan.

2. The method according to claim 1, further comprising:
determining an environmental image, position information, force information, and posture information corresponding to the robot;
determining the preset information based on the environmental image, the position information, the force information, and the posture information.

3. The method according to claim 2, wherein determining the motion state of the robot based on preset information corresponding to the robot comprises:
in response that an obstacle is located at a movement path of the robot according to the environmental image, determining a predetermined path to avoid the obstacle for the robot according to the position information;
determining an adjustment angle corresponding to the robot based on the predetermined path;
in response that the adjustment angle is greater than or equal to a first threshold, determining the motion state of the robot is in the non-balanced state;
in response that the adjustment angle is less than the first threshold, determining the motion state of the robot is in the balanced state.

4. The method according to claim 2, wherein determining the motion state of the robot based on preset information corresponding to the robot comprises:
determining a flatness of an operational area where the robot is located according to the environmental image;
in response that the flatness is less than or equal to a second threshold, adjusting a movement speed of the robot and determining the motion state of the robot based on the force information and the posture information;
in response that the flatness is greater than the second threshold, determining the motion state of the robot based on the force information and the posture information.

5. The method according to claim 2, wherein determining the motion state of the robot based on preset information corresponding to the robot comprises:
determining a length of an operational area where the robot is located in a preset direction based on the environmental image;
in response that the length is less than or equal to a third threshold, adjusting the movement speed of the robot and determining the motion state of the robot based on the force information and the posture information; and
in response that the length is greater than the third threshold, determining the motion state of the robot based on the force information and the posture information.

6. The method according to claim 5, wherein determining the motion state of the robot based on the force information and the posture information comprises:
determining a force position and a magnitude of the force corresponding to the robot based on the force information;
determining a motion posture of the robot based on the force position, the magnitude of the force, and the posture information;
in response that the robot is tilted according to the motion posture, checking the tilt angle of the robot;
in response that the tilt angle is greater than a fourth threshold, determining that the motion state of the robot is in the non-balanced state; and
in response that the tilt angle is less than or equal to the fourth threshold, determining that the motion state of the robot is in the balanced state.

7. The method according to claim 2, wherein obtaining the motion plan corresponding to the balance-assistance assembly comprises:
determining a motion component and motion information of the balance-assistance assembly based on a preset robot motion model and the preset information; and
obtaining the motion plan based on the motion component and the motion information.

8. A robot comprising:
a robot body and a balance-assistance assembly;
a storage device;
at least one processor; and
the storage device storing one or more programs that, when executed by the at least one processor, cause the at least one processor to:
determine a motion state of the robot based on preset information corresponding to the robot;
in response that the motion state is in a non-balanced state, obtain a motion plan corresponding to the balance-assistance assembly; and
control the motion state of the robot to change to a balanced state by controlling the balance-assistance assembly to move based on the motion plan.

9. The robot according to claim 8, wherein the at least one processor is further caused to:
determine an environmental image, position information, force information, and posture information corresponding to the robot;
determine the preset information based on the environmental image, the position information, the force information, and the posture information.

10. The robot according to claim 9, wherein the at least one processor determines the motion state of the robot based on preset information corresponding to the robot by:
in response that an obstacle is located at a movement path of the robot according to the environmental image, determining a predetermined path to avoid the obstacle for the robot according to the position information;
determining an adjustment angle corresponding to the robot based on the predetermined path;
in response that the adjustment angle is greater than or equal to a first threshold, determining the motion state of the robot is in the non-balanced state;
in response that the adjustment angle is less than the first threshold, determining the motion state of the robot is in the balanced state.

11. The robot according to claim 9, wherein the at least one processor determines the motion state of the robot based on preset information corresponding to the robot by:
determining a flatness of an operational area where the robot is located according to the environmental image;
in response that the flatness is less than or equal to a second threshold, adjusting a movement speed of the robot and determining the motion state of the robot based on the force information and the posture information;
in response that the flatness is greater than the second threshold, determining the motion state of the robot based on the force information and the posture information.

12. The robot according to claim 9, wherein the at least one processor determines the motion state of the robot based on preset information corresponding to the robot by:
determining a length of an operational area where the robot is located in a preset direction based on the environmental image;
in response that the length is less than or equal to a third threshold, adjusting the movement speed of the robot and determining the motion state of the robot based on the force information and the posture information; and
in response that the length is greater than the third threshold, determining the motion state of the robot based on the force information and the posture information.

13. The robot according to claim 12, wherein at least one processor determines the motion state of the robot based on the force information and the posture information by:
determining a force position and a magnitude of the force corresponding to the robot based on the force information;
determining a motion posture of the robot based on the force position, the magnitude of the force, and the posture information;
in response that the robot is tilted according to the motion posture, checking the tilt angle of the robot;
in response that the tilt angle is greater than a fourth threshold, determining that the motion state of the robot is in the non-balanced state; and
in response that the tilt angle is less than or equal to the fourth threshold, determining that the motion state of the robot is in the balanced state.

14. The robot according to claim 9, wherein at least one processor obtains the motion plan corresponding to the balance-assistance assembly by:
determining a motion component and motion information of the balance-assistance assembly based on a preset robot motion model and the preset information; and
obtaining the motion plan based on the motion component and the motion information.

15. A non-transitory storage medium having instructions stored thereon, when the instructions are executed by a processor of a robot, the robot comprising a robot body and a balance-assistance assembly, the processor is caused to perform a method for controlling the robot, wherein the method comprises:
determining a motion state of the robot based on preset information corresponding to the robot;
in response that the motion state is in a non-balanced state, obtaining a motion plan corresponding to the balance-assistance assembly; and
controlling the motion state of the robot to change to a balanced state by controlling the balance-assistance assembly to move based on the motion plan.

16. The non-transitory storage medium according to claim 15, wherein the method further comprises:
determining an environmental image, position information, force information, and posture information corresponding to the robot;
determining the preset information based on the environmental image, the position information, the force information, and the posture information.

17. The non-transitory storage medium according to claim 16, determining the motion state of the robot based on preset information corresponding to the robot comprises:
in response that an obstacle is located at a movement path of the robot according to the environmental image, determining a predetermined path to avoid the obstacle for the robot according to the position information;
determining an adjustment angle corresponding to the robot based on the predetermined path;
in response that the adjustment angle is greater than or equal to a first threshold, determining the motion state of the robot is in the non-balanced state;
in response that the adjustment angle is less than the first threshold, determining the motion state of the robot is in the balanced state.

18. The non-transitory storage medium according to claim 17, determining the motion state of the robot based on preset information corresponding to the robot comprises:
determining a flatness of an operational area where the robot is located according to the environmental image;
in response that the flatness is less than or equal to a second threshold, adjusting a movement speed of the robot and determining the motion state of the robot based on the force information and the posture information;
in response that the flatness is greater than the second threshold, determining the motion state of the robot based on the force information and the posture information.

19. The non-transitory storage medium according to claim 17, wherein determining the motion state of the robot based on preset information corresponding to the robot comprises:
determining a length of an operational area where the robot is located in a preset direction based on the environmental image;
in response that the length is less than or equal to a third threshold, adjusting the movement speed of the robot and determining the motion state of the robot based on the force information and the posture information; and
in response that the length is greater than the third threshold, determining the motion state of the robot based on the force information and the posture information.

20. The non-transitory storage medium according to claim 19, wherein determining the motion state of the robot based on the force information and the posture information comprises:
determining a force position and a magnitude of the force corresponding to the robot based on the force information;
determining a motion posture of the robot based on the force position, the magnitude of the force, and the posture information;
in response that the robot is tilted according to the motion posture, checking the tilt angle of the robot;
in response that the tilt angle is greater than a fourth threshold, determining that the motion state of the robot is in the non-balanced state; and
in response that the tilt angle is less than or equal to the fourth threshold, determining that the motion state of the robot is in the balanced state.
